(19) United States
(12) Patent Application Publication
(10) Pub. No.: US 2021/0389617 A1
(43) Pub. Date: Dec. 16, 2021

(54) LIQUID CRYSTAL DISPLAY PANEL

(71) Applicants: SAKAI DISPLAY PRODUCTS CORPORATION, Sakai-shi, Osaka (JP); SHARP KABUSHIKI KAISHA, Sakai City, Osaka (JP)

(72) Inventors: MITSUAKI HIRATA, Sakai-shi, Osaka (JP); FUMIKAZU SHIMOSHIKIRYOH, Sakai City, Osaka (JP)

(21) Appl. No.: 17/042,845

(22) PCT Filed: Mar. 30, 2018
(86) PCT No.: PCT/JP2018/013990

§ 371 Date: Dec. 11, 2020

(51) Int. Cl. G02F 1/1337; G02F 1/1343

(52) U.S. Cl. CPC G02F 1/1337; G02F 1/134309

(57) ABSTRACT

In a liquid crystal display panel, when a center line (C101) which extends along a longitudinal direction of a pixel and which passes through a center of a width direction of a pixel electrode (102) is defined, a boundary region (131) includes: a first portion (131a) provided on one side of the center line (C101) along a transverse direction of the pixel; and a second portion (131b) provided on another side of the center line (C101) along the transverse direction of the pixel. Among ends of the plurality of first slits (112A to 112G) that are closer to the boundary region (131), an end that is adjacent to the first portion (131a) of the boundary region (131) is located nearer the boundary region (131) than is an end that is adjacent to the second portion (131b) of the boundary region (131). Among ends of the plurality of second slits (122A to 122H) that are closer to the boundary region (131), an end that is adjacent to the second portion (131b) of the boundary region (131) is located nearer the boundary region (131) than is an end that is adjacent to the first portion (131a) of the boundary region (131).

### TECHNICAL FIELD

This invention relates to a liquid crystal display panel whose display mode is a VA mode.

### BACKGROUND ART

A liquid crystal display apparatus is a display apparatus which performs display by utilizing a liquid crystal composition. Under one representative displaying method, a liquid crystal composition is sealed in between a pair of substrates; a liquid crystal display panel including this pair of substrates and the liquid crystal composition, these being sandwiched between a pair of polarizers, is irradiated with light from a backlight; and a voltage is applied to the liquid crystal composition in order to change the alignment of the liquid crystal molecules, whereby the amount of light passing through the liquid crystal display panel is controlled. Such a liquid crystal display apparatus has advantages such as a thin profile, light weight, and low power consumption, and therefore is utilized in smartphones, tablet PCs, car navigation systems, and other electronic devices.

In some conventional liquid crystal display panels, one pixel is divided into a plurality of domains (alignment regions), such that liquid crystal molecules are aligned in a different azimuth in each domain, thereby improving viewing angle characteristics. Examples of the method of achieving such alignment division in a pixel are methods that divide a half pixel into four domains of two rows by two columns; currently, a 4D-RTN (4Domain-Reverse Twisted Nematic) mode of Patent Documents 1 and 2, and a 4D-ECB (4Domain-Electrically Controlled Birefringence) mode of Patent Document 2, and the like are under study.

At a boundary between regions of different alignment azimuths of liquid crystal molecules, owing to continuity of the liquid crystal molecules, there are always portions where the alignment direction of liquid crystal molecules is parallel to the polarization axis of one of the polarizers. When liquid crystal displaying is performed in such a state, the aforementioned portions are visible as dark lines because no light is transmitted therethrough, and thus the transmittance and contrast ratio are reduced.

FIG. 12 is a schematic plan view showing one pixel, illustrating an exemplary region in which a dark line 1120 may occur in the liquid crystal display panel of Patent Document 3.

In the aforementioned liquid crystal display panel of Patent Document 3, one pixel is divided into four domains of one column by four rows. More specifically, a pixel 1000 includes four domains 1000a to 1000d in which liquid crystal molecules 1041 have mutually different alignment azimuths (azimuths of tilt). The domains 1000a to 1000d are arranged along the longitudinal direction of the pixel 1000 (i.e., the up-down direction in FIG. 12). Herein, when an azimuth flush with the transverse direction of the pixel 1000 (i.e., the right-left direction in FIG. 12) is defined as 0°, an alignment azimuth of the liquid crystal molecules 1041 in the domain 1000a is 45°; an alignment azimuth of the liquid crystal molecules 1041 in the domain 1000b is 225°; an alignment azimuth of the liquid crystal molecules 1041 in the domain 1000c is 135°; and an alignment azimuth of the liquid crystal molecules 1041 in the domain 1000d is 315°.

Since the alignment azimuth of the liquid crystal molecules 1041 in the domain 1000a is different from the alignment azimuth of the liquid crystal molecules 1041 in the domain 1000b, a portion 1120b of the dark line 1120 extends along the boundary between the domain 1000a and the domain 1000b. Since the alignment azimuth of the liquid crystal molecules 1041 in the domain 1000c is different from the alignment azimuth of the liquid crystal molecules 1041 in the domain 1000d, another portion of the dark line 1120 extends along the boundary between the domain 1000c and the domain 1000d.

Because of the alignment azimuths of liquid crystal molecules 1041 being thus set, the portion 1120b of the dark line 1120 extends along the boundary between the domain 1000a and the domain 1000b, and the other portion 1120a of the dark line 1120 extends along the boundary between the domain 1000c and the domain 1000d.

What is depicted at 1011 in FIG. 12 is a wiring line.

### CITATION LIST

### Patent Literature

Patent Document 1: Japanese Patent No. 5184618
Patent Document 2: Japanese Laid-Open Patent Publication No. 2011-85738
Patent Document 3: International Publication No. 2017/047532

### SUMMARY OF INVENTION

### Technical Problem

The inventors have further conducted a simulation concerning occurrence of dark lines 1120 to observe the alignment states of the liquid crystal molecules.

FIG. 13 is a photographic representation of one pixel, showing a result of simulating occurrence of dark lines 1120. In FIG. 13, liquid crystal molecules 1041 are illustrated as bolt shapes. More specifically, heads of the bolts correspond to bottoms of the cones in FIG. 12. On the other hand, ends of the bolts opposite to their heads, i.e., the tips, correspond to apices of the cones in FIG. 12.

As is clear from FIG. 13, in each region containing a boundary between domains, a double dark line occurs, and also a disclination P1001, P1002 occurs in irregular manners. In other words, the site of the disclination P1001, P1002 differs for each double dark line. For example, in one double dark line, a disclination may occur in the central portion along the transverse direction of the pixel; in another double dark line, a disclination may occur at an end along the transverse direction of the pixel. This is because the location of a disclination is determined based on a balance between the alignment azimuths in the surrounding liquid crystal molecule alignment, and is affected by local variations in the pretilt angle, shape/electric field variations around the pixel electrode, etc., for example.

Therefore, in the aforementioned conventional liquid crystal display panel, the site of occurrence of the disclination P1001, P1002 is varied, thus resulting in a problem of coarse display.

Therefore, a problem to be solved by this invention is to improve on coarseness of display and provide a liquid crystal display panel with an enhanced display quality.

### Solution to Problem

A liquid crystal display panel according to one implementation of this invention is a liquid crystal display panel having a display mode that is a VA mode, comprising:

a plurality of rectangular-shaped pixels;

a first substrate section including a first substrate and pixel electrodes;

a liquid crystal layer provided on the first substrate section, the liquid crystal layer containing liquid crystal molecules; and

a second substrate section provided on the liquid crystal layer, the second substrate section including a second substrate and a counter electrode, wherein,

the plurality of pixels each include first and second domains arranged along a longitudinal direction of the pixel; when a direction orthogonal to the longitudinal direction of the pixel is defined as a transverse direction of the pixel and an azimuth flush with the transverse direction of the pixel is defined as 0°, an alignment azimuth of the liquid crystal molecules in the first domain is substantially 45° and an alignment azimuth of the liquid crystal molecules in the second domain is substantially 225°; or an alignment azimuth of the liquid crystal molecules in the first domain is substantially 135° and an alignment azimuth of the liquid crystal molecules in the second domain is substantially 315°;

each pixel electrode includes

a first slitted region in which a plurality of first slits extending along a direction that is parallel to the alignment azimuth of the liquid crystal molecules in the first domain are formed, and

a second slitted region in which a plurality of second slits extending along a direction that is parallel to the alignment azimuth of the liquid crystal molecules in the second domain are formed, and

a boundary region provided between the first slitted region and the second slitted region;

no slits are formed in the boundary region;

when a center line which extends along the longitudinal direction of the pixel and which passes through a center of a width direction of the pixel electrode is defined, the boundary region includes a first portion provided on one side of the center line along the transverse direction and a second portion provided on another side of the center line along the transverse direction;

among ends of the plurality of first slits that are closer to the boundary region, an end that is adjacent to the first portion of the boundary region is located nearer the boundary region than is an end that is adjacent to the second portion of the boundary region; and

among ends of the plurality of second slits that are closer to the boundary region, an end that is adjacent to the second portion of the boundary region is located nearer the boundary region than is an end that is adjacent to the first portion of the boundary region.

Herein, the aforementioned alignment azimuth of a liquid crystal molecule refers to, in a plan view of the liquid crystal molecule under an applied voltage across the liquid crystal layer, a direction from one end of the liquid crystal molecule along its major axis direction that is at the first substrate section side to the other end of the liquid crystal molecule along its major axis direction that is at the second substrate section side. In this case, when the alignment azimuth of a liquid crystal molecule is said to be 0°, this alignment azimuth corresponds to the rightward direction from one end of the liquid crystal molecule along its major axis direction that is at the first substrate section side (so-called the 3 o'clock direction). In that case, when the alignment azimuth of a liquid crystal molecule is said to be 45°, this alignment azimuth corresponds to an alignment azimuth that results through a 45° counterclockwise rotation from the 0° alignment azimuth of the liquid crystal molecule.

As referred to above, substantially 45° means an angle in the range from 30° to 60°, or an angle in the range from 40° to 50°. As referred to above, substantially 135° means an angle in the range from 150° to 120°, or an angle in the range from 140° to 130°. As referred to above, substantially 225° means an angle in the range from 210° to 240°, or an angle in the range from 220° to 230°. As referred to above, substantially 315° means an angle in the range from 300° to 330°, or an angle in the range from 310° to 320°.

Moreover, the aforementioned boundary region is a rectangular-shaped region including: a pair of shorter sides which are parallel to the longitudinal direction of the pixel and which are opposed to each other; and a pair of longer sides which are parallel to the transverse direction of the pixel and which are opposed to each other. Herein, among the ends of the plurality of first slits that are closer to the second slitted region, the end(s) that is/are the closes to the second slitted region is/are in contact with a shorter side of the rectangular region that is closer to the first slitted region. On the other hand, among the ends of the plurality of second slits that are closer to the first slitted region, the end(s) that is/are the closest to the first slitted region is/are in contact with a longer side of the rectangular region that is closer to the second slitted region.

### Advantageous Effects of Invention

In a liquid crystal display panel according to this invention, among the ends of the plurality of first slits that are closer to the boundary region, an end that is adjacent to the first portion of the boundary region is located nearer the boundary region than is an end that is adjacent to the second portion of the boundary region. On the other hand, among the ends of the plurality of second slits that are closer to the boundary region, an end that is adjacent to the second portion of the boundary region is located nearer the boundary region than is an end that is adjacent to the first portion of the boundary region. This makes it possible to improve on coarseness of display and provide an enhanced display quality.

### BRIEF DESCRIPTION OF DRAWINGS

FIG. 1 A schematic cross-sectional view of a liquid crystal display panel according to a first embodiment of the present invention.

FIG. 2 A schematic cross-sectional view of the liquid crystal display panel according to the first embodiment.

FIG. 3 A schematic perspective view for describing the attitudes of liquid crystal molecules according to the first embodiment.

FIG. 4 An enlarged plan view of a pixel electrode according to the first embodiment and its neighborhood.

FIG. 5 An enlarged plan view of a first pixel electrode portion of the aforementioned pixel electrode.

FIG. 6 An enlarged plan view of a second pixel electrode portion of the aforementioned pixel electrode.

FIG. 7 A photographic representation of a simulation of dark lines in the first embodiment.

FIG. 8 A plan view showing enlarged a pixel electrode according to a second embodiment of this invention and its neighborhood.

FIG. 9 An enlarged plan view of a first pixel electrode portion of the aforementioned pixel electrode.

FIG. 10 An enlarged plan view of a second pixel electrode portion of the aforementioned pixel electrode.

FIG. 11 A photographic representation of a simulation of dark lines in the second embodiment.

FIG. 12 A schematic plan view for describing a dark line in a conventional liquid crystal display panel.

FIG. 13 A photographic representation of a simulation of the aforementioned dark lines.

### DESCRIPTION OF EMBODIMENTS

Hereinafter, by way of embodiments illustrated in the drawings, liquid crystal display panels according to this invention will be described in more detail. In the drawings, common portions are denoted by like numerals, with any redundant description being omitted.

### First Embodiment

FIG. 1 is a cross-sectional view schematically showing a cross section of a liquid crystal display panel according to a first embodiment of this invention.

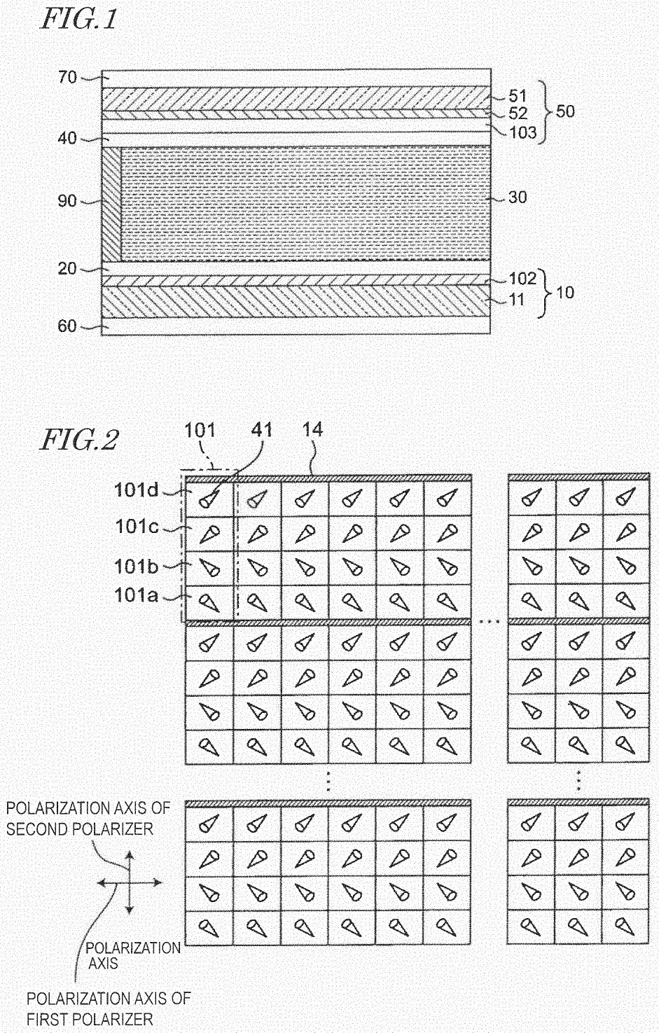

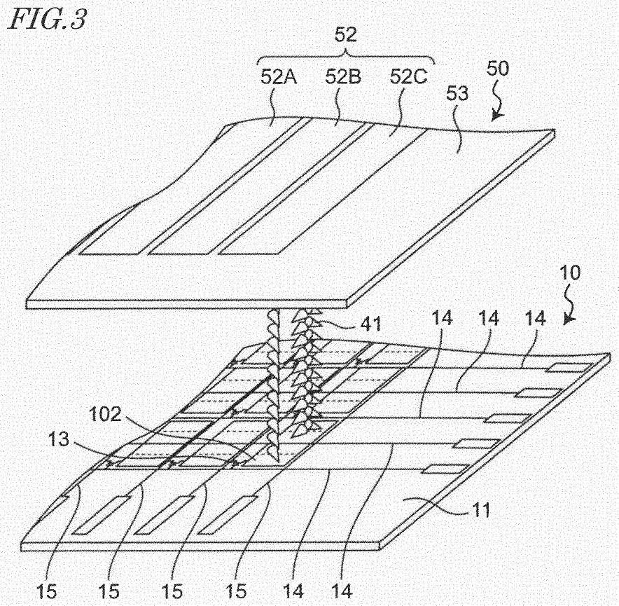

The liquid crystal display panel is a liquid crystal display panel whose display mode is a VA mode, including: a first substrate section 10; a first vertical alignment film 20; a liquid crystal layer 30 containing liquid crystal molecules 41 (shown in FIG. 2 and FIG. 3); a second vertical alignment film 40; and a second substrate section 50. The first vertical alignment film 20, the liquid crystal layer 30, the second vertical alignment film 40, and the second substrate section 50 are stacked in this order on the first substrate section 10. Between the first vertical alignment film 20 and the second vertical alignment film 40, a sealing member 90 with which to seal the liquid crystal layer 30 is provided. Herein, light from the first substrate section 10 side passes through the liquid crystal layer 30, and thereafter travels toward the second substrate section 50 side. In other words, the aforementioned light enters into the liquid crystal display panel and then goes out from the liquid crystal display panel at the second substrate section 50 side.

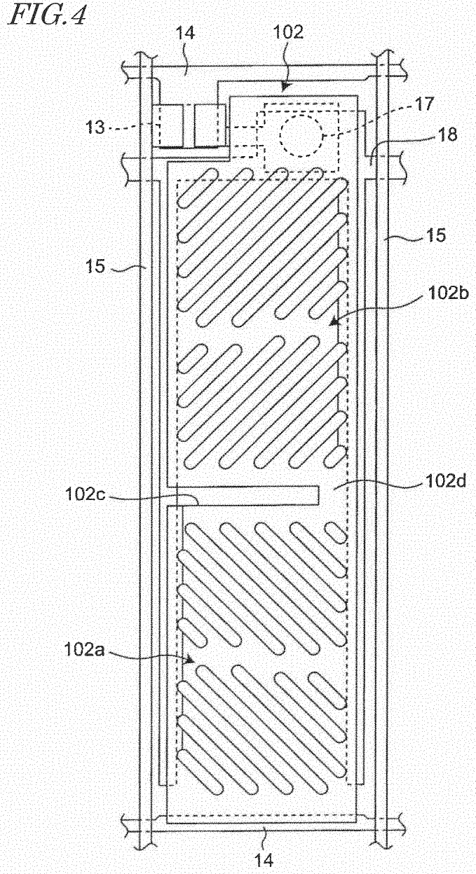

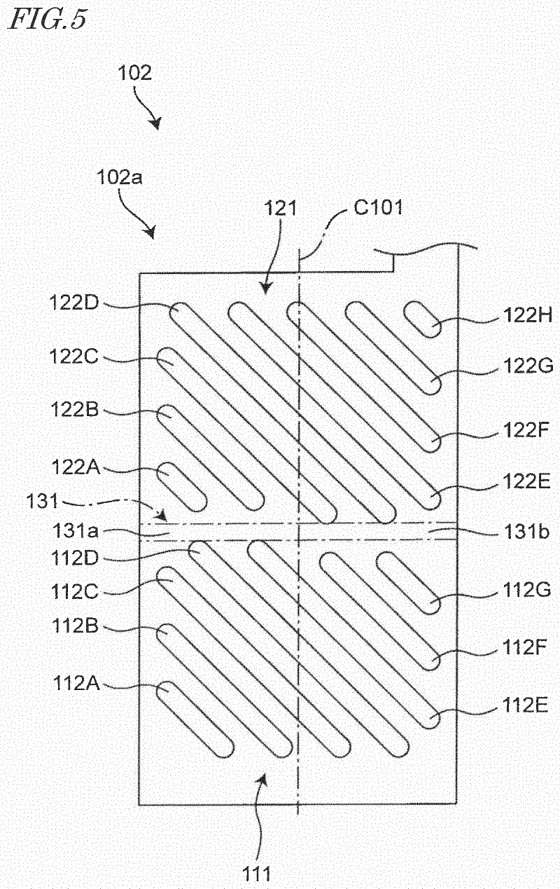

The first substrate section 10 includes a first glass substrate 11 and pixel electrodes 102 provided on an upper surface of the glass substrate 11. Also, thin film transistors 13 (shown in FIG. 3 and FIG. 4) are provided on the upper surface of the glass substrate 11, the thin film transistors 13 being electrically connected to the pixel electrodes 102. Under the first substrate section 10, a first polarizer 60 is disposed. Note that the first glass substrate 11 is an example of a first substrate.

The second substrate section 50 includes a second glass substrate 51, a color filter 52, and a counter electrode 103. Along the thickness direction of the second glass substrate 51, the color filter 52 is opposed to the pixel electrodes 102. On the second substrate section 50, a second polarizer 70 having a polarization axis that is orthogonal to a polarization axis (transmission axis) of the first polarizer 60 is disposed. Note that the second glass substrate 51 is an example of a second substrate.

The pixel electrodes 102 and the counter electrode 103 may each be a transparent electrode of ITO (Indium Tin Oxide), for example.

FIG. 2 is a plan view schematically showing the liquid crystal display panel. In FIG. 2, liquid crystal molecules 41 under an applied voltage across the liquid crystal layer 30 are depicted by cone shapes. More specifically, one end of each liquid crystal molecule 41 along its major axis direction that corresponds to the apex of the cone is located at the first substrate section 10 side. On the other hand, the other end of each liquid crystal molecule 41 along the major axis direction that corresponds to the bottom of the cone is located at the second substrate section 50 side.

In the liquid crystal display panel, a plurality of rectangular shaped pixels 101 are arranged in a matrix. Each pixel 101 includes four domains 101a to 101d, which differ from one another in terms of the alignment azimuth of the liquid crystal molecules 41. Moreover, the domains 101a to 101d are arranged along the longitudinal direction of the pixel 101 (i.e., the up-down direction in FIG. 2). Note that the domains 101a and 101c are examples of first domains. The domains 101b and 101d are examples of second domains.

When the liquid crystal display panel is viewed from the second substrate section 50 side, assuming that a direction that is orthogonal to the longitudinal direction of each pixel 101 is defined as the transverse direction of the pixel 101 (i.e., the right-left direction in FIG. 2), and that an azimuth from the left side in FIG. 2 toward the right side in FIG. 2 along this transverse direction (i.e., an azimuth from one end of the liquid crystal molecule 41 along its major axis direction toward the right side in FIG. 2) is defined as 0° then an alignment azimuth of the liquid crystal molecules 41 in the domain 101a is substantially 135°; an alignment azimuth of the liquid crystal molecules 41 in the domain 101b is substantially 315°; an alignment azimuth of the liquid crystal molecules 41 in the domain 101c is substantially 45°; and an alignment azimuth of the liquid crystal molecules 41 in the second domain is substantially 225°. These alignment azimuths may be conferred by irradiating a photoalignment film with polarized UV light through a mask, for example.

Moreover, in order to enhance the transmittance of the liquid crystal layer 30, the transverse direction of the pixel 101 is set so as to be parallel to the polarization axis of the first polarizer 60.

Herein, the alignment azimuth of a liquid crystal molecule 41 is an orientation that does not take into account any tilt angle (pretilt angle) with respect to the normal direction of the upper surface of the first glass substrate 11. More specifically, the alignment azimuth of a liquid crystal molecule 41 means a direction in which the other end (i.e., the end at the second substrate section 50 side) of the liquid crystal molecule 41 along its major axis direction is oriented, when the liquid crystal molecule 41 is projected onto the upper surface of the first glass substrate 11, i.e., when the liquid crystal molecule 41 is viewed from the second substrate section 50 side. For example, the liquid crystal molecule 41 are arranged in such a manner that: if the alignment azimuth of a liquid crystal molecule 41 is 100, when that liquid crystal molecule 41 is viewed from the second substrate section 50 side, the direction in which the other end of the liquid crystal molecule 41 along its major axis direction is oriented (i.e., the direction from one end of the liquid crystal molecule 41 along its major axis direction to the other end of the liquid crystal molecule 41 along its major axis direction) constitutes 10° with respect to the direction from one end of the liquid crystal molecule 41 along its major axis direction toward the right side in FIG. 2. Note that any angle in a counterclockwise direction with respect to the direction from one end of the liquid crystal molecule 41 along its major axis direction toward the right side in FIG. 2 is assumed to have a positive value.

As referred to above, substantially 45° means an angle in the range from 30° to 60°, or an angle in the range from 40° to 50°. As referred to above, substantially 135° means an angle in the range from 150° to 120°, or an angle in the range from 140° to 130°. As referred to above, substantially 225° means an angle in the range from 210° to 240°, or an angle in the range from 220° to 230°. As referred to above, substantially 315° means an angle in the range from 300° to 330°, or an angle in the range from 310° to 320°.

In FIG. 2, a gate line extending along the transverse direction of the pixels 101 is depicted at 14.

FIG. 3 is a schematic perspective view for describing the attitudes of the liquid crystal molecules 41 under an applied voltage across the liquid crystal layer 30.

In the domain 101a, the liquid crystal molecules 41 have an essentially constant tilt angle between the pixel electrode 102 and the counter electrode 103. Similarly, in each of the domains 101b, 101c and 101d, the liquid crystal molecules 41 have an essentially constant tilt angle between the pixel electrode 102 and the counter electrode 103. Herein, the tilt angle of a liquid crystal molecule 41 means an angle which the major axis of the liquid crystal molecule 41 constitutes with the upper surface of the glass substrate 11.

A plurality of pixel electrodes 102 are disposed in a matrix, so as to be in rectangular-shaped regions. Each such region is a region that is delineated by a plurality of gate lines 14, 14, . . . , which are parallel to one another and a plurality of source lines 15, 15, . . . , which are parallel to one another.

The gate lines 14, 14, . . . are provided on the first glass substrate 11, and extend along a direction which is parallel to the transverse direction of the pixels 101. Moreover, each gate line 14 is electrically connected to gates of thin film transistors 13.

The source lines 15 are provided on the first glass substrate 11, and extend along a direction which is parallel to the longitudinal direction of the pixels 101. Moreover, each source line 15 is electrically connected to sources of thin film transistors 13.

As the thin film transistors 13, those having channels made by using silicon or an oxide semiconductor are suitably used, for example. As such an oxide semiconductor, for example, a compound composed of indium, gallium, zinc, and oxygen (In—Ga—Zn—O), a compound composed of indium, tin, zinc, and oxygen (In-Tin-Zn—O), or a compound composed of indium, aluminum, zinc, and oxygen (In—Al—Zn—O) can be used.

As the gate lines 14 and the source lines 15, those which are commonly used in the field of liquid crystal display panels can be used, e.g., a metal such as copper, titanium, chromium, aluminum, or molybdenum, or an alloy thereof, etc.

The color filter 52 is composed of red color filters 52A, green color filters 52B, and blue color filters 52C. The red color filters 52A, the green color filters 52B, and the blue color filters 52C are each located above a plurality of pixel electrodes 102 that are arranged along the longitudinal direction of the pixels 101, and extend along the longitudinal direction of the pixels 101.

FIG. 4 is an enlarged plan view of a pixel electrode 102 and its neighborhood.

A drain of the thin film transistor 13 is electrically connected to a drain line 16. The drain line 16 is electrically connected also to the pixel electrode 102, via an electrical conductor in a contact hole 17.

Within each rectangular-shaped region that is delineated by the gate lines 14, 14, . . . and the source lines 15, 15, . . . , a capacitor line 18 is also formed. The capacitor line 18 is formed so as to extend along three sides of the pixel electrode 14, and is electrically connected to the pixel electrode 102.

The pixel electrode 102 includes: a first pixel electrode portion 102a opposed to the domains 101a and 101b along the thickness direction (i.e., a direction perpendicular to the plane of the figure of FIG. 4); and a second pixel electrode portion 102b opposed to the domains 101c and 101d along the thickness direction. Between the first pixel electrode portion 102a and the second pixel electrode portion 102b, a rectangular-shaped recess 102c and a bridging portion 102d are provided along the transverse direction of the pixel 101.

The recess 102c extends from one of the pair of longer sides of the pixel electrode 102 to the other one of the pair of longer sides. In other words, the recess 102c is formed so as to extend along the transverse direction of the pixel 101.

The bridging portion 102d is a portion that connects between the first pixel electrode portion 102a and the second pixel electrode portion 102b, and is formed so as to adjoin the recess 102c. The bridging portion 102d is located closer to the other one of the pair of longer sides.

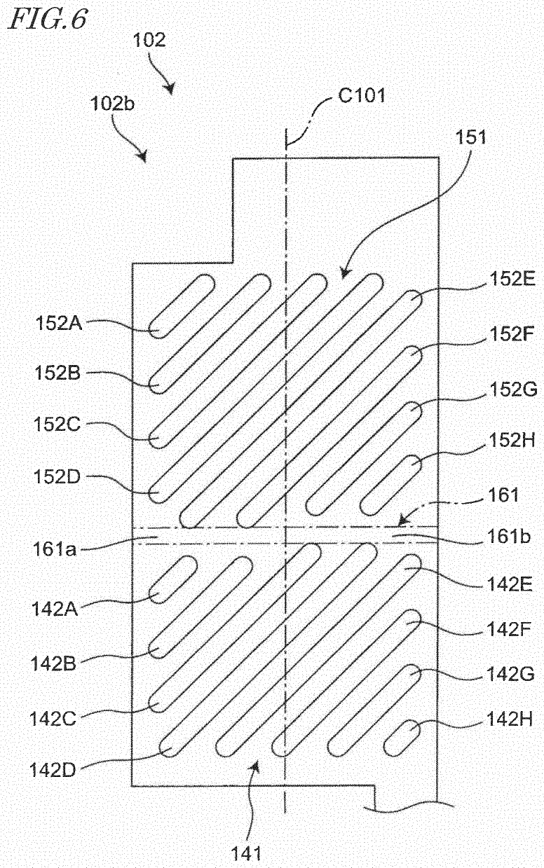

FIG. 5 is a plan view showing enlarged the first pixel electrode portion 102a.

The first pixel electrode portion 102a includes: a first slitted region 111 opposed to the domain 101a along the thickness direction (i.e., a direction perpendicular to the plane of the figure of FIG. 5); a second slitted region 121 opposed to the domain 101b along the thickness direction; and a boundary region 131.

In the first slitted region 111, seven slits 112A to 112G extending along a direction parallel to the alignment azimuth of the liquid crystal molecules 41 in the domain 101a are formed. Note that the slits 112A to 112G are examples of first slits.

The slits 112A to 112G are mutually equal in width, while being set to mutually different lengths. The width of the slits 112A to 112G is set to e.g. 3.0 μm. The interval between the slits 112A to 112G is also set to e.g. 3.0 μm. In other words, the design pitch of the slits 112A to 112G may be set to e.g. 6.0 μm. Note that, in terms of improving transmittance of the pixel 101 the design pitch is preferably e.g. 7.0 μm or less, and in terms of facilitating fabrication the design pitch is preferably e.g. 5.2 μm or more.

In the second slitted region 121, eight slits 122A to 122H extending along a direction parallel to the alignment azimuth of the liquid crystal molecules in the domain 101b are formed. Note that the slits 122A to 122H are examples of second slits.

The slits 122A to 122H also are mutually equal in width, while being set to mutually different lengths. The width of the slits 122A to 122H is set to the same width as the width of the slits 112A to 112G. Moreover, the interval between the slits 122A to 122H is also set to the same interval as the interval between the slits 112A to 112G. Note that, in terms of improving transmittance of the pixel 101, the design pitch of the slits 122A to 122H also is e.g. 7.0 μm or less, and in terms of facilitating fabrication the design pitch is preferably e.g. 5.2 μm or more.

The boundary region 131 is provided between the first slitted region 111 and the second slitted region 121. The width of the boundary region 131 (i.e., the length along the up-down direction in FIG. 5) is set to a narrower width than the width of the slits 112A to 112G or the slits 122A to 122H. Moreover, the boundary region 131 includes first and second portions 131a and 131b arranged along the transverse direction of the pixel 101. Slits are formed in neither one of the first and second portions 131a and 131b. The first portion 131a is disposed closer to one side of the pixel electrode 102 (i.e., one side of the pixel 101 in a direction along the transverse direction) than is a center line C101 of the pixel electrode 102. Moreover, the second portion 131b is provided closer to the other side of the pixel electrode 102 (i.e., the other side of the pixel 101 in a direction along the transverse direction) than is the center line C101 of the pixel electrode 102. In other words, regarding the center line C101 of the pixel electrode 102, the first portion 131a is located on one side, while the second portion 131b is located on the other side. Stated otherwise, the first and second portions 131a and 131b are provided on opposite sides regarding the center line C101 of the pixel electrode 102.

Regarding the first portion 131a of the boundary region 131, the ends of the slits 112A to 112E that are closer to the boundary region 131 are disposed at one side in a direction along the longitudinal direction of the pixel 101 (i.e., the lower side in FIG. 5). Moreover, regarding the first portion 131a of the boundary region 131, the ends of the slits 122A, 122B that are closer to the boundary region 131 are disposed at the other side in the direction along the longitudinal direction of the pixel 101 (i.e., the upper side in FIG. 5). Moreover, in the direction along the longitudinal direction of the pixel 101, the ends of the slits 112C to 112E, 122A, 122B that are closer to the boundary region 131 are adjacent to the first portion 131a of the boundary region 131.

Regarding the second portion 131b of the boundary region 131, the ends of the slits 112F, 112G that are closer to the boundary region 131 are disposed at one side in a direction along the longitudinal direction of the pixel 101. Moreover, regarding the second portion 131b of the boundary region 131, the ends of the slits 122C to 122H that are closer to the boundary region 131 are disposed at the other side in the direction along the longitudinal direction of the pixel 101. Moreover, in the direction along the longitudinal direction of the pixel 101, the ends of the slits 112F, 112G, 122C to 122E that are closer to the boundary region 131 are adjacent to the second portion 131b of the boundary region 131.

The longer side of the boundary region 131 that is closer to the first slitted region 111 has a predetermined interval between itself and the ends of the slits 112C, 112F, 112G that are closer to the boundary region 131. On the other hand, the ends of the slits 112D, 112E that are closer to the boundary region 131 are in contact with the longer side of the boundary region 131 that is closer to the first slitted region 111.

The longer side of the boundary region 131 that is closer to second slitted region 121 has a predetermined interval between itself and the ends of the slits 122A, 122B, 122E that are closer to the boundary region 131. On the other hand, the ends of the slits 122C, 122D that are closer to the boundary region 131 are in contact with the longer side of the boundary region 131 that is closer to the second slitted region 121.

Moreover, the ends of the slits 112D, 112E that are closer to the boundary region 131 are mutually aligned in the transverse direction of the pixel 101. Moreover, the ends of the slits 112F, 112G that are closer to the boundary region 131 are also mutually aligned in the transverse direction of the pixel 101. Furthermore, the ends of the slits 112D, 112E that are closer to the boundary region 131 are located nearer the boundary region 131 than are the ends of the slits 112A to 112C, 112F, 112G that are closer to the boundary region 131. Stated otherwise, the ends of the slits 112D, 112E that are closer to the boundary region 131 are disposed relatively near the boundary region 131. The ends of the slits 112A to 112C, 112F, 112G that are closer to the boundary region 131 are disposed relatively far from the boundary region 131. More specifically, the ends of the slits 112D, 112E that are closer to the boundary region 131 reach the boundary region 131, but the ends of the slits 112A to 112C, 112F, 112G that are closer to the boundary region 131 do not reach the boundary region 131.

Moreover, the ends of the slits 122A, 122B that are closer to the boundary region 131 are mutually aligned in the transverse direction of the pixel 101. Moreover, the ends of the slits 122C, 122D that are closer to the boundary region 131 are also mutually aligned in the transverse direction of the pixel 101. Furthermore, the ends of the slits 122C, 122D that are closer to the boundary region 131 are located nearer the boundary region 131 than are the ends of the slits 122A, 122B, 122E to 122H that are closer to the boundary region 131. Stated otherwise, the ends of the slits 122C, 122D that are closer to the boundary region 131 are disposed relatively near the boundary region 131. On the other hand, the ends of the slits 122A, 122B, 122E to 122H that are closer to the boundary region 131 are disposed relatively far from the boundary region 131. More specifically, the ends of the slits 122C, 122D that are closer to the boundary region 131 reach the boundary region 131, but the ends of the slits 122A, 122B, 122E to 122H that are closer to the boundary region 131 do not reach the boundary region 131.

Moreover, a figure that is presented by the ends of the slits 112D to 112G that are closer to the boundary region 131 and the ends of the slits 122A to 122D that are closer to the boundary region 131 is a point-symmetric figure. The center of symmetry thereof is located slightly to the left side in FIG. 5 relative to the center line C101 in the boundary region 131. Note that the ends of the slits 112D to 112G that are closer to the boundary region 131 and the ends of the slits 122A to 122D that are closer to the boundary region 131 may be disposed so that the center of symmetry is located upon the center line in the boundary region 131.

Moreover, the ends of the slits 112D to 112G that are closer to the boundary region 131 and the ends of the slits 122A to 122D that are closer to the boundary region 131 are opposed to one another in a direction along the longitudinal direction of the pixel 101.

Moreover, as shown in FIG. 5, the center line C101 passes through a center of the width (i.e., the length along the right-left direction in FIG. 5) of the pixel electrode 102, and extends along the longitudinal direction of the pixel 101.

FIG. 6 is a plan view showing enlarged the second pixel electrode portion 102b.

The second pixel electrode portion 102b includes: a first slitted region 141 opposed to the domain 101c along the thickness direction (i.e., a direction perpendicular to the plane of the figure of FIG. 6); a second slitted region 151 opposed to the domain 101d along the thickness direction; and a boundary region 161.

In the first slitted region 141, eight slits 142A to 142H extending along a direction parallel to the alignment azimuth of the liquid crystal molecules 41 in the domain 101c are formed. Note that the slits 142A to 142H are examples of first slits.

The slits 142A to 142H are mutually equal in width, while being set to mutually different lengths. The width of the slits 142A to 142H is set to e.g. 3.0 μm. Moreover, the interval between the slits 142A to 142H is also set to e.g. 3.0 μm. In other words, the design pitch of the slits 142A to 142H is set to e.g. 6.0 μm. Note that, in terms of improving transmittance of the pixel 101 the design pitch is preferably e.g. 7.0 μm or less, and in terms of facilitating fabrication the design pitch is preferably e.g. 5.2 μm or more.

In the second slitted region 151, eight slits 152A to 152H extending along a direction parallel to the alignment azimuth of the liquid crystal molecules in the domain 101d are formed. Note that the slits 152A to 152H are examples of second slits.

The slits 152A to 152H also are mutually equal in width, while being set to mutually different lengths. The width of the slits 152A to 152H is set to the same width as the width of the slits 142A to 142H. Moreover, the interval between the slits 152A to 152H is set to the same interval as the interval between the slits 142A to 142H. Note that, in terms of improving transmittance of the pixel 101, the design pitch of the slits 152A to 152H also is e.g. 7.0 μm or less, and in terms of facilitating fabrication the design pitch is preferably e.g. 5.2 μm or more.

The boundary region 161 is provided between the first slitted region 141 and the second slitted region 151. The width of the boundary region 161 (i.e., the length along the up-down direction in FIG. 6) is set to a narrower width than the width of the slits 142A to 142H or the slits 152A to 152H. Moreover, the boundary region 161 includes first and second portions 161a and 161b arranged along the transverse direction of the pixel 101. Slits are formed in neither one of the first and second portions 161a and 161b. Herein, the first portion 161a is disposed closer to one side of the pixel electrode 102 (i.e., one side of the pixel 101 in a direction along the transverse direction) than is the center line C101 of the pixel electrode 102. Moreover, the second portion 161b is provided closer to the other side of the pixel electrode 102 (i.e., the other side of the pixel 101 in a direction along the transverse direction) than is the center line C101 of the pixel electrode 102. In other words, regarding the center line C101 of the pixel electrode 102, the first portion 161a is located on one side, while the second portion 161b is located on the other side. Stated otherwise, the first and second portions 161a and 161b are provided on opposite sides regarding the center line C101 of the pixel electrode 102.

Regarding the first portion 161a of the boundary region 161, the ends of the slits 142A, 142B that are closer to the boundary region 161 are disposed at one side in a direction along the longitudinal direction of the pixel 101 (i.e., the lower side in FIG. 6). Moreover, regarding the first portion 161a of the boundary region 161, the ends of the slits 152A to 152F that are closer to the boundary region 161 are disposed at the other side in the direction along the longitudinal direction of the pixel 101 (i.e., the upper side in FIG. 6). Moreover, in the direction along the longitudinal direction of the pixel 101, the ends of the slits 142A, 142B, 152D to 152F that are closer to the boundary region 161 are adjacent to the first portion 161a of the boundary region 161.

Regarding the second portion 161b of the boundary region 161, the ends of the slits 142C to 142H that are closer to the boundary region 161 are disposed at one side in a direction along the longitudinal direction of the pixel 101. Moreover, regarding the second portion 161b of the boundary region 161, the ends of the slits 152G, 152H that are closer to the boundary region 161 are disposed at the other side in the direction along the longitudinal direction of the pixel 101. Moreover, in the direction along the longitudinal direction of the pixel 101, the ends of the slits 142C to 142E, 152G, 152H that are closer to the boundary region 161 are adjacent to the second portion 161b of the boundary region 161.

The longer side of the boundary region 161 that is closer to the first slitted region 141 has a predetermined interval between itself and the ends of the slits 142A, 142B, 142E that are closer to the boundary region 161. On the other hand, the ends of the slits 142C, 142D that are closer to the boundary region 161 are in contact with the longer side of the boundary region 161 that is closer to the first slitted region 141.

The longer side of the boundary region 161 that is closer to the second slitted region 151 has a predetermined interval between itself and the ends of the slits 152D, 152G, 152H that are closer to the boundary region 161. On the other hand, the ends of the slits 152E, 152F that are closer to the boundary region 161 are in contact with the longer side of the boundary region 161 that is closer to the second slitted region 151.

Moreover, the ends of the slits 142A, 142B that are closer to the boundary region 161 are mutually aligned in the transverse direction of the pixel 101. Moreover, the ends of the slits 142C, 142D that are closer to the boundary region 161 are also mutually aligned in the transverse direction of the pixel 101. Furthermore, the ends of the slits 142C, 142D that are closer to the boundary region 161 are located nearer the boundary region 161 than are the ends of the slits 142A, 142B, 142E to 142H that are closer to the boundary region 161. Stated otherwise, the ends of the slits 142C, 142D that are closer to the boundary region 161 are disposed relatively near the boundary region 161. On the other hand, the ends of the slits 142A, 142B, 142E to 142H that are closer to the boundary region 161 are disposed relatively far from the boundary region 161. More specifically, the ends of the slits 142C, 142D that are closer to the boundary region 161 reach the boundary region 161, but the ends of the slits 142A, 142B, 142E to 142H that are closer to the boundary region 161 do not reach the boundary region 161.

Moreover, the ends of the slits 152E, 152F that are closer to the boundary region 161 are mutually aligned in the transverse direction of the pixel 101. Moreover, the ends of the slits 152G, 152H that are closer to the boundary region 161 are also mutually aligned in the transverse direction of the pixel 101. Furthermore, the ends of the slits 152E, 152F that are closer to the boundary region 161 are located nearer the boundary region 161 than are the ends of the slits 152A to 152D, 152G, 152H that are closer to the boundary region 161. Stated otherwise, the ends of the slits 152E, 152F that are closer to the boundary region 161 are disposed relatively near the boundary region 161. On the other hand, the ends of the slits 152A to 152D, 152G, 152H that are closer to the boundary region 161 are disposed relatively far from the boundary region 161. More specifically, the ends of the slits 152E, 152F that are closer to the boundary region 161 reach the boundary region 161, but the ends of the slits 152A to 152D, 152G, 152H that are closer to the boundary region 161 do not reach the boundary region 161.

Moreover, a figure that is presented by the ends of the slits 142A to 142D that are closer to the boundary region 161 and the ends of the slits 152E to 152H that are closer to the boundary region 161 is a point-symmetric figure. The center of symmetry thereof is located slightly to the left side in FIG. 6 relative to the center line C101 in the boundary region 161. Note that the ends of the slits 142A to 142D that are closer to the boundary region 161 and the ends of the slits 152E to 152H that are closer to the boundary region 161 may be disposed so that the center of symmetry is located upon the center line in the boundary region 161.

Moreover, the ends of the slits 142A to 142D that are closer to the boundary region 161 and the ends of the slits 152E to 152H that are closer to the boundary region 161 are opposed to one another in a direction along the longitudinal direction of the pixel 101.

With the liquid crystal display panel of the above configuration, in the first slitted region 111, the ends of the slits 112D, 112E that are closer to the boundary region 131 are located nearer the boundary region 131 than are the ends of the slits 112F, 112G that are closer to the boundary region 131. Moreover, in the second slitted region 121, the ends of the slits 122C, 122D that are closer to the boundary region 131 are located nearer the boundary region 131 than are the ends of the slits 122A, 122E that are closer to the boundary region 131. As a result, when a double dark line occurs in a portion above the first pixel electrode portion 102a of the pixel 101 due to application of a voltage across the liquid crystal layer 30, a disclination in the double dark line can be caused in a specific site on the boundary region 131.

Moreover, the ends of the slits 142C, 142D that are closer to the boundary region 161 are located nearer the boundary region 161 than are the ends of the slits 142A, 142B that are closer to the boundary region 161. Moreover, the ends of the slits 152E, 152F that are closer to the boundary region 161 are located nearer the boundary region 161 than are the ends of the slits 152G, 152H that are closer to the boundary region 161. As a result, when a double dark line occurs in a portion above the first pixel electrode portion 102b of the pixel 101 due to application of a voltage across the liquid crystal layer 30, a disclination in the double dark line can be caused in a specific site on the boundary region 161.

Therefore, in the portions above the first and second pixel electrode portions 102a and 102b of the pixel 101, variation in the sites of occurrence of a disclination in the double dark line can be suppressed, thereby making it possible to improve on coarseness of display and provide an enhanced display quality.

Moreover, since no slit are formed in the boundary regions 131 and 161, the following effects are provided based on the settings of their widths.

The width of the boundary region 131 is set to a narrower width than the width of the slits 112A to 112G or the slits 122A to 122H. Thus, in the region of the liquid crystal display panel corresponding to the first pixel electrode portion 102a, the region in which a double dark line occurs under an applied voltage can be narrowed, whereby decrease in transmittance can be suppressed effectively.

Moreover, the width of the boundary region 161 is set to a narrower width than the width of the slits 142A to 142H or the slits 152A to 152H. Thus, in the region of the liquid crystal display panel corresponding to the second pixel electrode portion 102b, the region in which a double dark line occurs under an applied voltage can be narrowed, whereby decrease in transmittance can be suppressed effectively.

Moreover, in the first slitted region 111 of the first pixel electrode portion 102a, the two slits 112D, 112E are provided nearer the boundary region 131 than are the two slits 112F, 112G. Moreover, in the second slitted region 121 of the first pixel electrode portion 102a, the two slits 122C, 122D are provided nearer the boundary region 131 than are the two slits 122A, 122B. Therefore, in the portion above the first pixel electrode portion 102a of the pixel 101, an enhanced effect of suppressing variation in the sites of occurrence of a disclination in a double dark line can be provided.

Moreover, in the first slitted region 141 of the second pixel electrode portion 102b, the two slits 142C, 142D are provided nearer the boundary region 161 than are the two slits 142A, 142B. Moreover, in the second slitted region 151 of the second pixel electrode portion 102b, the ends of the two slits 152E, 152F that are closer to the boundary region 161 are provided nearer the boundary region 161 than are the ends of the two slits 152G, 152H. Therefore, in the portion above the second pixel electrode portion 102b of the pixel 101, an enhanced effect of suppressing variation in the sites of occurrence of a disclination in a double dark line can be provided.

Moreover, in the first pixel electrode portion 102a, the ends of the slits 112D, 112E that are closer to the boundary region 131 are aligned, in a direction along the longitudinal direction of the pixel 101, to the ends of the slits 122A, 122B that are closer to the boundary region 131. Moreover, in the first pixel electrode portion 102a, the ends of the slits 112F, 112G that are closer to the boundary region 131 are aligned, in the direction along the longitudinal direction of the pixel 101, to the ends of the slits 122C, 122D that are closer to the boundary region 131. Therefore, in the portion above the first pixel electrode portion 102a of the pixel 101, an enhanced effect of suppressing variation in the sites of occurrence of a disclination in a double dark line can be provided.

Moreover, in the second pixel electrode portion 102b, the ends of the slits 142A, 142B that are closer to the boundary region 161 are aligned, in a direction along the longitudinal direction of the pixel 101, to the ends of the slits 152E, 152F that are closer to the boundary region 161. Moreover, in the second pixel electrode portion 102b, the ends of the slits 142C, 142D that are closer to the boundary region 161 are aligned, in the direction along the longitudinal direction of the pixel 101, to the ends of the slits 152G, 152H that are closer to the boundary region 161. Therefore, in the portion above the second pixel electrode portion 102b of the pixel 101, an enhanced effect of suppressing variation in the sites of occurrence of a disclination in a double dark line can be provided.

Moreover, a figure that is presented by the ends of the slits 112D to 112G that are closer to the boundary region 131 and the ends of the slits 122A to 122D that are closer to the boundary region 131 is a point-symmetric figure. Therefore, although a double dark line will occur upon voltage application to the first pixel electrode portion 102a, the effect of suppressing variation in the sites of occurrence of a disclination in a double dark line is more enhanced than in the case where the figure that is presented by their ends is not a point-symmetric figure.

Moreover, a figure that is presented by the ends of the slits 142A to 142D that are closer to the boundary region 161 and the ends of the slits 152E to 152H that are closer to the boundary region 161 is a point-symmetric figure. Therefore, although a double dark line will occur upon voltage application to the second pixel electrode portion 102a, the effect of suppressing variation in the sites of occurrence of a disclination in a double dark line is more enhanced than in the case where the figure that is presented by their ends is not a point-symmetric figure.

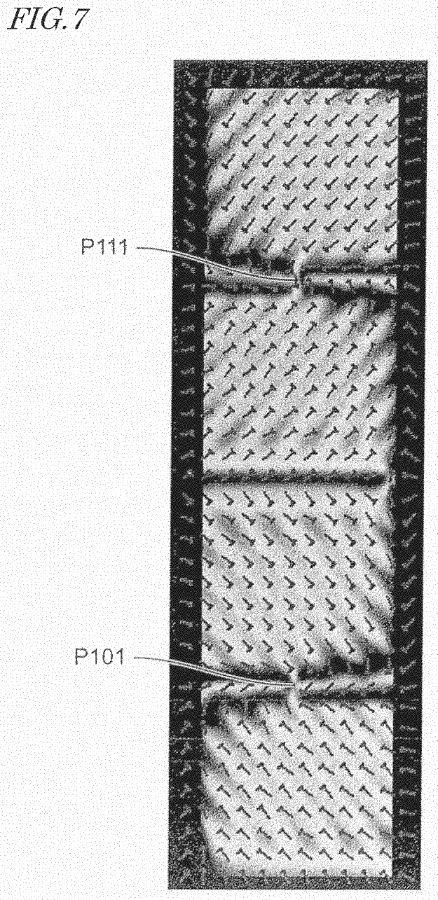

FIG. 7 is a photographic representation of one pixel, illustrating a result of simulating occurrence of dark lines in the first embodiment. In FIG. 7, liquid crystal molecules 41 under an applied voltage across the liquid crystal layer 30 are depicted as bolt shapes. More specifically, heads of the bolts correspond to bottoms of the cones in FIG. 2 and FIG. 3. On the other hand, ends of the bolts opposite to their heads, i.e., the tips, correspond to apices of the cones in FIG. 2 and FIG. 3.

It can be seen from FIG. 7 that a disclination P101 occurs so as to overlap the boundary region 131 and the center line C101 of the first pixel electrode portion 102a, and a disclination P111 occurs so as to overlap the boundary region 161 and the center line C101 of the second pixel electrode portion 102b, and that the disclination P101 and the disclination P111 are mutually aligned in the longitudinal direction of the pixel 101.

In the first embodiment, the domains 101a to 101d are arranged in the order from domains 101a to 101d. Without being limited to this order, however, they may be arranged in the order of domains 101b, 101a, 101d and 101c, for example. In the case where they are arranged in the order of domains 101b, 101a, 101d and 101c, similar actions and effects as those in the first embodiment can be obtained, without having to change the shape of the pixel electrode 102.

In the first embodiment, the domains 101a and 101b are provided farther away from the thin film transistor 13 of the pixel electrode 102 than are the domains 101c and 101d; alternatively, they may be provided near the thin film transistor 13 of the pixel electrode 102. In other words, a configuration may be adopted in which the places of the domains 101a and 101b and the places of the domains 101c and 101d are exchanged.

In the first embodiment, the pixel 101 includes the domains 101a to 101d. However, the pixel 101 may be configured so as to include the domains 101a and 101b but not the domains 101c and 101d; alternatively, the pixel 101 may be configured so as to include the domains 101c and 101d but not the domains 101a and 101b. In other words, a single pixel 101 may only include the domains 101a and 101b alone, or the domains 101c and 101d alone.

In the first embodiment, the polarization axis of the first polarizer 60 is parallel to the transverse direction of the pixels 101, and the polarization axis of the second polarizer 70 is parallel to the longitudinal direction of the pixels 101. However, the polarization axis of the first polarizer 60 may be parallel to the longitudinal direction of the pixels 101, while the polarization axis of the second polarizer 70 may be parallel to the transverse direction of the pixels 101.

In the first embodiment, the gate lines 14 are not formed so as to overlap the central portion of the longitudinal direction of the pixel electrode 102; however, they may be formed so as to overlap the central portion of the longitudinal direction of the pixel electrode 102. When adopting this, the direction that the gate lines 14 extend may be parallel to the transverse direction of the pixel 101, or non-parallel to the transverse direction of the pixel 101.

In the first embodiment, the width of the slits 112A to 112G and the interval between the slits 112A to 112G are equal; however, they may be different.

In the first embodiment, the width of the slits 122A to 122H and the interval between the slits 122A to 122H are equal; however, they may be different.

In the first embodiment, assuming that the pixel electrode 102 has a length L along the transverse direction, the first and second portions 131a and 131b each have a length of L/2 along the transverse direction; however, for example, the first portion 131a may have a length of L/3, while the second portion 131b may have a length of 2L/3.

In the first embodiment, the ends of the slits 112D to 112G that are closer to the boundary region 131 and the ends of the slits 122A to 122D that are closer to the boundary region 131 constitute a point-symmetric figure; however, a point-symmetric figure may be constituted by only the ends of the slits 112E to 112G that are closer to the boundary region 131 and the ends of the slits 122B to 122D that are closer to the boundary region 131, for example. Alternatively, a point-symmetric figure may be constituted by only the ends of the slits 112E, 112F that are closer to the boundary region 131 and the ends of the slits 122B, 122C that are closer to the boundary region 131. Alternatively, a point-symmetric figure may be constituted by only the end of the slit 112F that is closer to the boundary region 131 and the end of the slit 122B that is closer to the boundary region 131.

In the first embodiment, the number of slits formed in the first slitted region 111 is seven, but any plural number other than seven may also be adopted.

In the first embodiment, the number of slits formed in the second slitted region 121, the first slitted region 141, and the second slitted region 151 is eight, but any plural number other than eight may also be adopted.

In the first embodiment, the ends of the slits 142A to 142D that are closer to the boundary region 161 and the ends of the slits 152E to 152H that are closer to the boundary region 161 constitute a point-symmetric figure; however, a point-symmetric figure may be constituted by only the ends of the slits 142B to 142D that are closer to the boundary region 161 and the ends of the slits 152E to 152G that are closer to the boundary region 161, for example. Alternatively, a point-symmetric figure may be constituted by only the ends of the slits 142B, 142C that are closer to the boundary region 161 and the ends of the slits 152F, 152G that are closer to the boundary region 161. Alternatively, a point-symmetric figure may be constituted by only the end of the slit 142B that is closer to the boundary region 161 and the end of the slit 152G that is closer to the boundary region 161.

In the first embodiment, the width of the boundary region 131 is set to a width that is narrower than the width of the slits 112A to 112G or than the slits 122A to 122H; however, for example, it may be set to a width that is narrower than the width of the slits 112A to 112G and yet broader than the width of the slits 122A to 122H. Alternatively, it may be set to a width that is broader than the width of the slits 112A to 112G and yet narrower than the width of the slits 122A to 122H.

In the first embodiment, the width of the boundary region 161 is set to a width that is narrower than the width of the slits 142A to 142H or than the slits 152A to 152H; however, for example, it may be set to a width that is narrower than the width of the slits 142A to 142H and yet broader than the width of the slits 152A to 152H. Alternatively, it may be set to a width that is broader than the width of the slits 142A to 142H and yet narrower than the width of the slits 152A to 152H.

### Second Embodiment

Hereinafter, a liquid crystal display panel according to a second embodiment of this invention will be described, where any constituent elements that are identical to constituent element of the first embodiment will be denoted by identical reference numerals to those of the constituent elements in the first embodiment.

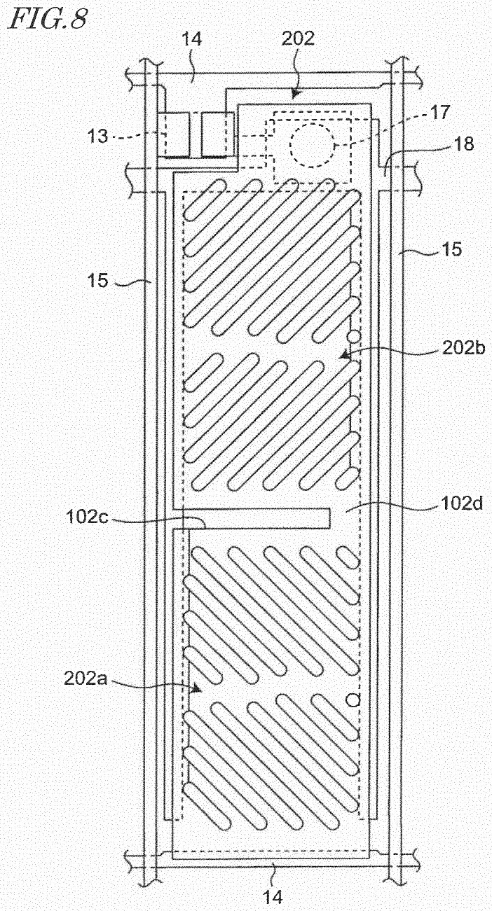

FIG. 8 is a plan view showing enlarged a pixel electrode 202 included in a liquid crystal display panel according to a second embodiment of this invention, and its neighborhood.

The liquid crystal display panel according to the second embodiment differs from the liquid crystal display panel according to the first embodiment in that it includes the pixel electrode 202 instead of the pixel electrode 102. In the liquid crystal display panel according to the second embodiment, any portion other than the pixel electrode 202 is configured similarly to its counterpart in the liquid crystal display panel according to the first embodiment.

The pixel electrode 202 includes: a first pixel electrode portion 202a opposed to the domains 101a and 101b along the thickness direction (i.e., a direction perpendicular to the plane of the figure of FIG. 8); and a second pixel electrode portion 202b opposed to the domains 101c and 101d along the thickness direction.

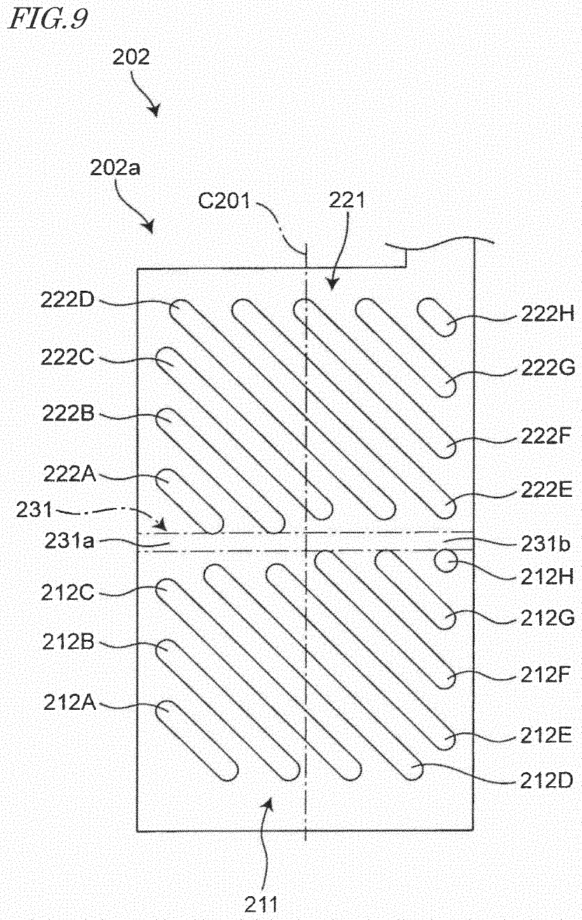

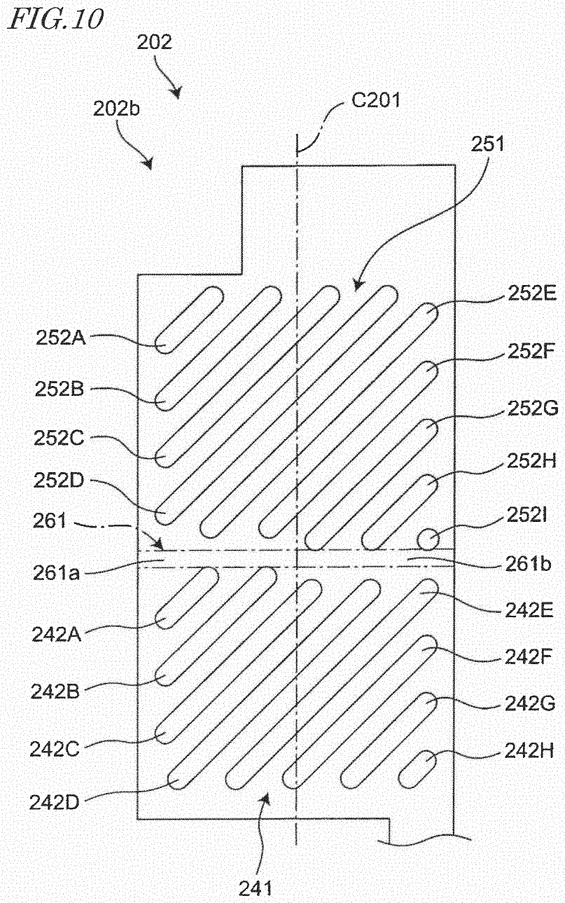

FIG. 9 is a plan view showing enlarged the first pixel electrode portion 202a.

The first pixel electrode portion 202a includes: a first slitted region 211 opposed to the domain 101a along the thickness direction (i.e., a direction perpendicular to the plane of the figure of FIG. 9); a second slitted region 221 opposed to the domain 101b along the thickness direction; and a boundary region 231.

In the first slitted region 211, eight slits 212A to 212H extending along a direction parallel to the alignment azimuth of the liquid crystal molecules 41 in the domain 101a are formed. Note that the slits 212A to 212H are examples of first slits.

The slits 212A to 212H are mutually equal in width, while being set to mutually different lengths. The width of the slits 212A to 212H is set to e.g. 3.0 μm. Moreover, the interval between the slits 212A to 212H is also set to e.g. 3.0 μm. In other words, the design pitch of the slits 212A to 212H may be set to e.g. 6.0 μm. Note that, in terms of improving transmittance of the pixel 101 the design pitch is preferably e.g. 7.0 μm or less, and in terms of facilitating fabrication the design pitch is preferably e.g. 5.2 μm or more.

In the second slitted region 221, eight slits 222A to 222H extending along a direction parallel to the alignment azimuth of the liquid crystal molecules 41 in the domain 101b are formed. Note that the slits 222A to 222H are examples of second slits.

The slits 222A to 222H also are mutually equal in width, while being set to mutually different lengths. The width of the slits 222A to 222H is set to the same width as the width of the slits 212A to 212H. Moreover, the interval between the slits 222A to 222H is also set to the same interval as the interval between the slits 212A to 212H. Note that, in terms of improving transmittance of the pixel 101, the design pitch of the slits 222A to 222H also is e.g. 7.0 μm or less, and in terms of facilitating fabrication the design pitch is preferably e.g. 5.2 μm or more.

The boundary region 231 is provided between the first slitted region 211 and the second slitted region 221. The width of the boundary region 231 (i.e., the length along the up-down direction in FIG. 9) is set to a narrower width than the width of the slits 212A to 212H or the slits 222A to 222H. Moreover, the boundary region 231 includes first and second portions 231a and 231b arranged along the transverse direction of the pixel 101. Slits are formed in neither one of the first and second portions 231a and 231b. Herein, the first portion 231a is disposed closer to one side of the pixel electrode 202 (i.e., one side of the pixel 101 in a direction along the transverse direction) than is a center line C201 of the pixel electrode 202. Moreover, the second portion 231b is provided closer to the other side of the pixel electrode 202 (i.e., the other side of the pixel 101 in a direction along the transverse direction) than is the center line C201 of the pixel electrode 202. In other words, regarding the center line C201 of the pixel electrode 202, the first portion 231a is located on one side, while the second portion 231b is located on the other side. Stated otherwise, the first and second portions 231a and 231b are provided on opposite sides regarding the center line C201 of the pixel electrode 202.

Regarding the first portion 231a of the boundary region 231, the ends of the slits 212A to 212E that are closer to the boundary region 231 are disposed at one side in a direction along the longitudinal direction of the pixel 101 (i.e., the lower side in FIG. 9). Moreover, regarding the first portion 231a of the boundary region 231, the ends of the slits 222A, 222B that are closer to the boundary region 231 are disposed at the other side in the direction along the longitudinal direction of the pixel 101 (i.e., the upper side in FIG. 9). Moreover, in the direction along the longitudinal direction of the pixel 101, the ends of the slits 212C to 212E, 222A, 222B that are closer to the boundary region 231 are adjacent to the first portion 231a of the boundary region 231.

Regarding the second portion 231b of the boundary region 231, the ends of the slits 212F to 212H that are closer to the boundary region 231 are disposed at one side in a direction along the longitudinal direction of the pixel 101. Moreover, regarding the second portion 231b of the boundary region 231, the ends of the slits 222C to 222H that are closer to the boundary region 231 are disposed at the other side in the direction along the longitudinal direction of the pixel 101. Moreover, in the direction along the longitudinal direction of the pixel 101, the ends of the slits 212F to 212H, 222C to 222E that are closer to the boundary region 231 are adjacent to the second portion 231b of the boundary region 231.

The longer side of the boundary region 231 that is closer to the first slitted region 211 has a predetermined interval between itself and the ends of the slits 212C to 212E that are closer to the boundary region 231. On the other hand, the ends of the slits 212F, 212G that are closer to the boundary region 231 are in contact with the longer side of the boundary region 231 that is closer to the first slitted region 211.

The longer side of the boundary region 231 that is closer to the second slitted region 221 has a predetermined interval between itself and the ends of the slits 222C to 222E that are closer to the boundary region 231. On the other hand, the ends of the slits 222A, 222B that are closer to the boundary region 231 are in contact with the longer side of the boundary region 231 that is closer to the second slitted region 221.

Moreover, the ends of the slits 212D, 212E that are closer to the boundary region 231 are mutually aligned in the transverse direction of the pixel 101. Moreover, the ends of the slits 212F to 212H that are closer to the boundary region 231 are mutually aligned in the transverse direction of the pixel 101. Furthermore, the ends of the slits 212F to 212H that are closer to the boundary region 231 are located nearer the boundary region 231 than are the ends of the slits 212A to 212E that are closer to the boundary region 231. Stated otherwise, the ends of the slits 212F to 212H that are closer to the boundary region 231 are disposed relatively near the boundary region 231. On the other hand, the ends of the slits 212A to 212E that are closer to the boundary region 231 are disposed relatively far from the boundary region 231. More specifically, the ends of the slits 212F to 212H that are closer to the boundary region 231 reach the boundary region 231, but the ends of the slits 212A to 212E that are closer to the boundary region 231 do not reach the boundary region 231.

Moreover, the ends of the slits 222A, 222B that are closer to the boundary region 231 are mutually aligned in the transverse direction of the pixel 101. Moreover, the ends of the slits 222C to 222E that are closer to the boundary region 231 are mutually aligned in the transverse direction of the pixel 101. Furthermore, the ends of the slits 222A, 222B that are closer to the boundary region 231 are located nearer the boundary region 231 than are the ends of the slits 222C to 222H that are closer to the boundary region 231. Stated otherwise, the ends of the slits 222A, 222B that are closer to the boundary region 231 are disposed relatively near the boundary region 231. On the other hand, the ends of the slits 222C to 222H that are closer to the boundary region 231 are disposed relatively far from the boundary region 231. More specifically, the ends of the slits 222A, 222B that are closer to the boundary region 231 reach the boundary region 231, but the ends of the slits 222C to 222H that are closer to the boundary region 231 do not reach the boundary region 231.

Moreover, a figure that is presented by the ends of the slits 212D to 212G that are closer to the boundary region 231 and the ends of the slits 222A to 222D that are closer to the boundary region 231 is a point-symmetric figure. The center of symmetry thereof is located on the center line C201 in the boundary region 231.

Moreover, the ends of the slits 212D to 212G that are closer to the boundary region 231 and the ends of the slits 222A to 222D that are closer to the boundary region 231 are opposed to one another in a direction along the longitudinal direction of the pixel 101.

Moreover, as shown in FIG. 9, the center line C201 passes through a center of the width (i.e., the length along the right-left direction in FIG. 9) of the pixel electrode 202, and extends along the longitudinal direction of the pixel 101.

FIG. 10 is a plan view showing enlarged the second pixel electrode portion 202b.

The second pixel electrode portion 202b includes: a first slitted region 241 opposed to the domain 101c along the thickness direction (i.e., a direction perpendicular to the plane of the figure of FIG. 10); a second slitted region 251 opposed to the domain 101d along the thickness direction; and a boundary region 261.

In the first slitted region 241, eight slits 242A to 242H extending along a direction parallel to the alignment azimuth of the liquid crystal molecules 41 in the domain 101c are formed. Note that the slits 242A to 242H are examples of first slits.

The slits 242A to 242H are mutually equal in width, while being set to mutually different lengths. The width of the slits 242A to 242H is set to e.g. 3.0 μm. Moreover, the interval between the slits 242A to 242H is also set to e.g. 3.0 μm. In other words, the design pitch of the slits 242A to 242H may be set to e.g. 6.0 μm. Note that, in terms of improving transmittance of the pixel 101 the design pitch is preferably e.g. 7.0 μm or less, and in terms of facilitating fabrication the design pitch is preferably e.g. 5.2 μm or more.

In the second slitted region 251, nine slits 252A to 252I extending along a direction parallel to the alignment azimuth of the liquid crystal molecules 41 in the domain 101d are formed. Note that the slits 252A to 252I are examples of second slits.

The slits 252A to 252I also are mutually equal in width, while being set to mutually different lengths. The width of the slits 252A to 252I is set to the same width as the width of the slits 242A to 242H. Moreover, the interval between the slits 252A to 252I is set to the same interval as the interval between the slits 242A to 242H. Note that, in terms of improving transmittance of the pixel 101, the design pitch of the slits 252A to 252I also is e.g. 7.0 μm or less, and in terms of facilitating fabrication the design pitch is preferably e.g. 5.2 μm or more.

The boundary region 261 is provided between the first slitted region 241 and the second slitted region 251. The width of the boundary region 261 (i.e., the length along the up-down direction in FIG. 10) is set to a narrower width than the width of the slits 242A to 242H or the slits 252A to 252I. Moreover, the boundary region 261 includes first and second portions 261a and 261b arranged along the transverse direction of the pixel 101. Slits are formed in neither one of the first and second portions 261a and 261b. Herein, the first portion 261a is disposed closer to one side of the pixel electrode 202 (i.e., one side of the pixel 101 in a direction along the transverse direction) than is the center line C201 of the pixel electrode 202. Moreover, the second portion 261b is provided closer to the other side of the pixel electrode 202 (i.e., the other side of the pixel 101 in a direction along the transverse direction) than is the center line C201 of the pixel electrode 202. In other words, regarding the center line C201 of the pixel electrode 202, the first portion 261a is located on one side, while the second portion 261b is located on the other side. Stated otherwise, the first and second portions 261a and 261b are provided on opposite sides regarding the center line C201 of the pixel electrode 202.

Regarding the first portion 261a of the boundary region 261, the ends of the slits 242A, 242B that are closer to the boundary region 261 are disposed at one side in a direction along the longitudinal direction of the pixel 101 (i.e., the lower side in FIG. 10). Moreover, regarding the first portion 261a of the boundary region 261, the ends of the slits 252A to 252F that are closer to the boundary region 261 are disposed at the other side in the direction along the longitudinal direction of the pixel 101 (i.e., the upper side in FIG. 10). Moreover, in the direction along the longitudinal direction of the pixel 101, the ends of the slits 242A, 242B, 252D to 252F that are closer to the boundary region 231 are adjacent to the first portion 261a of the boundary region 261.

Regarding the second portion 261b of the boundary region 261, the ends of the slits 242C to 242H that are closer to the boundary region 261 are disposed at one side in a direction along the longitudinal direction of the pixel 101. Moreover, regarding the second portion 261b of the boundary region 261, the ends of the slits 252G to 252I that are closer to the boundary region 261 are disposed at the other side in the direction along the longitudinal direction of the pixel 101. Moreover, in the direction along the longitudinal direction of the pixel 101, the ends of the slits 242C to 242E, 252G to 252I that are closer to the boundary region 261 are adjacent to the second portion 261b of the boundary region 261.

The longer side of the boundary region 261 that is closer to the first slitted region 241 has a predetermined interval between itself and the ends of the slits 242C to 242E that are closer to the boundary region 261. On the other hand, the ends of the slits 242A, 242B that are closer to the boundary region 261 are in contact with the longer side of the boundary region 261 that is closer to the first slitted region 241.

The longer side of the boundary region 261 that is closer to the second slitted region 251 has a predetermined interval between itself and the ends of the slits 252D to 252F that are closer to the boundary region 261. On the other hand, the ends of the slits 252G to 252I that are closer to the boundary region 261 are in contact with the longer side of the boundary region 261 that is closer to the second slitted region 251.

Moreover, the ends of the slits 242A, 242B that are closer to the boundary region 261 are mutually aligned in the transverse direction of the pixel 101. Moreover, the ends of the slits 242C to 242E that are closer to the boundary region 261 also are mutually aligned in the transverse direction of the pixel 101. Furthermore, the ends of the slits 242A, 242B that are closer to the boundary region 261 are located nearer the boundary region 261 than are the ends of the slits 242C to 242H that are closer to the boundary region 261. Stated otherwise, the ends of the slits 242A, 242B that are closer to the boundary region 261 are disposed relatively near the boundary region 261. On the other hand, the ends of the slits 242C to 242H that are closer to the boundary region 261 are disposed relatively far from the boundary region 261. More specifically, the ends of the slits 242A, 242B that are closer to the boundary region 261 reach the boundary region 261, but the ends of the slits 242C to 242H that are closer to the boundary region 261 do not reach the boundary region 261.

Moreover, the ends of the slits 252E, 252F that are closer to the boundary region 261 are mutually aligned in the transverse direction of the pixel 101. Moreover, the ends of the slits 252G to 252I that are closer to the boundary region 261 also are mutually aligned in the transverse direction of the pixel 101. Furthermore, the ends of the slits 252G to 252I that are closer to the boundary region 261 are located nearer the boundary region 261 than are the ends of the slits 252A to 252F that are closer to the boundary region 261. Stated otherwise, the ends of the slits 252G to 252I that are closer to the boundary region 261 are disposed relatively near the boundary region 261. The ends of the slits 252A to 252F that are closer to the boundary region 261 are disposed relatively far from the boundary region 261. More specifically, the ends of the slits 252G to 252I that are closer to the boundary region 261 reach the boundary region 261, but the ends of the slits 252A to 252F that are closer to the boundary region 261 do not reach the boundary region 261.

Moreover, a figure that is presented by the ends of the slits 242A to 242D that are closer to the boundary region 261 and the ends of the slits 252E to 252H that are closer to the boundary region 261 is a point-symmetric figure. The center of symmetry thereof is located on the center line C201 in the boundary region 261.

Moreover, the ends of the slits 242A to 242D that are closer to the boundary region 261 and the ends of the slits 252E to 252H that are closer to the boundary region 161 are opposed to one another in a direction along the longitudinal direction of the pixel 101.

With the liquid crystal display panel of the above configuration, no slits are formed in the boundary regions 231 and 261. Furthermore, a point-symmetric figure is constituted by the ends of the slits 212D to 212G, 222A to 222D that are closer to the boundary region 231, and a point-symmetric figure is constituted by the ends of the slits 242A to 242D, 252E to 252H that are closer to the boundary region 261. As a result, similar actions and effects as those in the first embodiment are obtained.

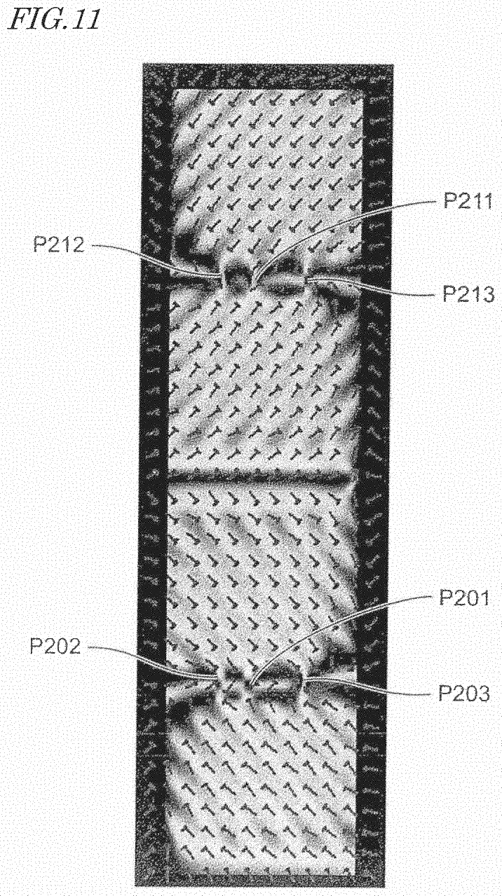

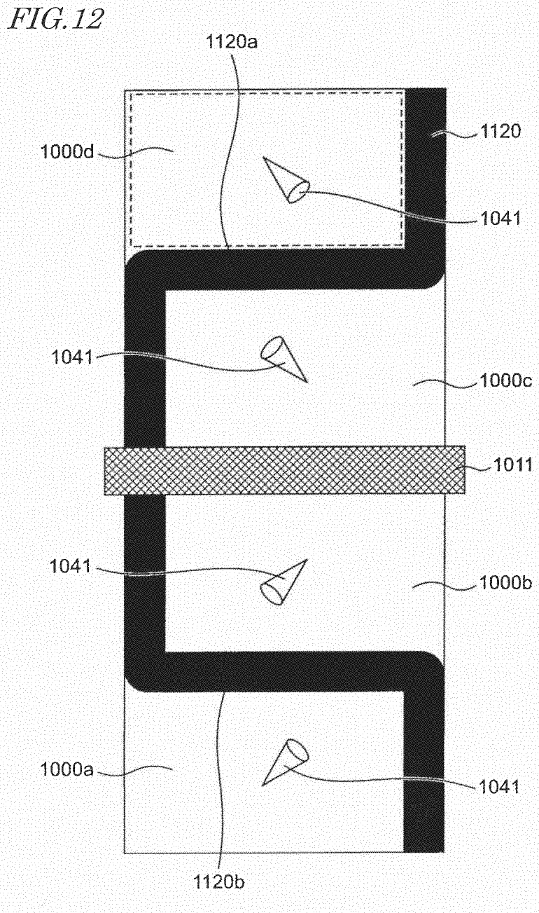

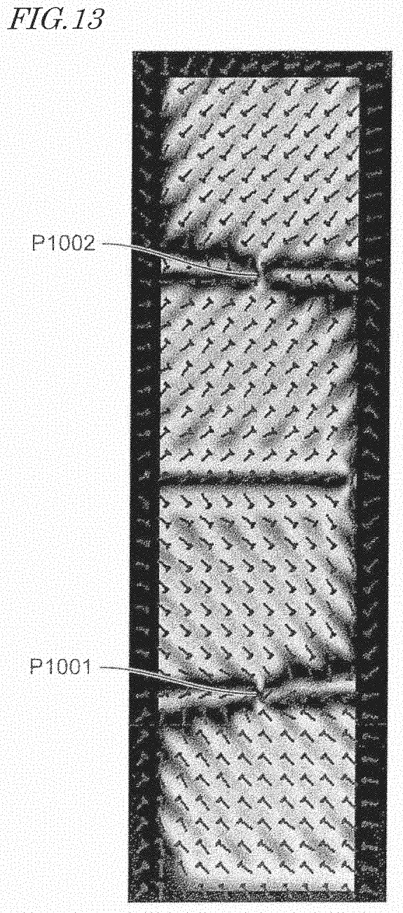

FIG. 11 is a photographic representation of one pixel, illustrating a result of simulating occurrence of dark lines in the second embodiment. In FIG. 11, similarly to FIG. 7, liquid crystal molecules 41 under an applied voltage across the liquid crystal layer 30 are depicted as bolt shapes.

It can be seen from FIG. 11 that a disclination P201 occurs near above the center of symmetry of a figure that is presented by the ends of the slits 212D to 212G, 222A to 222D that are closer to the boundary region 231. It can also be seen that a disclination P211 occurs near above the center of symmetry of a figure that is presented by the ends of the slits 242A to 242D, 252E to 252H that are closer to the boundary region 261.

Moreover, it can also be seen that disclinations P202 and P203 also occur above the first pixel electrode portion 202a, and disclinations P212 and P213 also occur above the second pixel electrode portion 202b, but that disclinations P202 and P203 are aligned, in the longitudinal direction of the pixel 101, to the disclinations P212 and P213.

Although specific embodiments of this invention have been described, this invention is not to be limited to the above-described first and second embodiments and variations thereof; rather, this invention can be practiced with various alterations within its scope. For example, some of the details described in the first and second embodiments may be deleted or replaced to provide an embodiment of this invention. Moreover, alterations as described for the first embodiment may be applied to the second embodiment to provide an embodiment of this invention.

Moreover, description of Japanese Patent No. 5184618, Japanese Laid-Open Patent Publication No. 2011-85738, and International Publication No. 2017/047532 is also applicable to the liquid crystal display panel of this invention. For example, as examples of materials and production methods of liquid crystal display panels according to this invention, the materials and production methods, etc., described in Japanese Patent No. 5184618 Japanese Laid-Open Patent Publication No. 2011-85738, and International Publication No. 2017/047532 can be adopted.

That is, the above disclosure can be summarized as follows.

A liquid crystal display panel according to one implementation of this invention is

a liquid crystal display panel having a display mode that is a VA mode, including:

a plurality of rectangular-shaped pixels 101;

a first substrate section 10 including a first substrate 11 and pixel electrodes 102, 202;

a liquid crystal layer 30 provided on the first substrate section 10, the liquid crystal layer 30 containing liquid crystal molecules 41; and

a second substrate section 50 provided on the liquid crystal layer 30, the second substrate section 50 including a second substrate 51 and a counter electrode 103, wherein,

the plurality of pixels 101 each include first and second domains 101a, 101c, 101b, 101d arranged along a longitudinal direction of the pixel 101; when a direction orthogonal to the longitudinal direction of the pixel 101 is defined as a transverse direction of the pixel 101 and an azimuth flush with the transverse direction of the pixel 101 is defined as 0°, an alignment azimuth of the liquid crystal molecules 41 in the first domain 101a, 101c is substantially 45° and an alignment azimuth of the liquid crystal molecules 41 in the second domain 101b, 101d is substantially 225°; or an alignment azimuth of the liquid crystal molecules 41 in the first domain 101a, 101c is substantially 135° and an alignment azimuth of the liquid crystal molecules 41 in the second domain 101b, 101d is substantially 315°;

each pixel electrode 102, 202 includes

a first slitted region 111, 141, 211, 241 in which a plurality of first slits 112A to 112G, 142A to 142H, 212A to 212H, 242A to 242H extending along a direction that is parallel to the alignment azimuth of the liquid crystal molecules 41 in the first domain 101a, 101c are formed, and

a second slitted region 121, 151, 221, 251 in which a plurality of second slits 122A to 122H, 152A to 152H, 222A to 222H, 252A to 252I extending along a direction that is parallel to the alignment azimuth of the liquid crystal molecules 41 in the second domain 101b, 101d are formed, and

a boundary region 131, 161, 231, 261 provided between the first slitted region 111, 141, 211, 241 and the second slitted region 121, 151, 221, 251;

no slits are formed in the boundary region 131, 161, 231, 261;

when a center line C101, C201 which extends along the longitudinal direction of the pixel 101 and which passes through a center of a width direction of the pixel electrode 102, 202 is defined, the boundary region 131, 161, 231, 261 includes a first portion 131a, 161a, 231a, 261a provided on one side of the center line C101, C201 along the transverse direction and a second portion 131b, 161b, 231b, 261b provided on another side of the center line C101, C201 along the transverse direction;

among ends of the plurality of first slits 112A to 112G, 142A to 142H, 212A to 212H, 242A to 242H that are closer to the boundary region 131, 161, 231, 261, an end that is adjacent to the first portion 131a, 161a, 231a, 261a of the boundary region 131, 161, 231, 261 is located nearer the boundary region 131, 161, 231, 261 than is an end that is adjacent to the second portion 131b, 161b, 231b, 261b of the boundary region 131, 161, 231, 261; and

among ends of the plurality of second slits 122A to 122H, 152A to 152H, 222A to 222H, 252A to 252I that are closer to the boundary region 131, 161, 231, 261, an end that is adjacent to the second portion 131b, 161b, 231b, 261b of the boundary region 131, 161, 231, 261 is located nearer the boundary region 131, 161, 231, 261 than is an end that is adjacent to the first portion 131a, 161a, 231a, 261a of the boundary region 131, 161, 231, 261.

In the liquid crystal display panel of the above configuration, when a voltage is applied to the liquid crystal layer 30, a double dark line occurs near the boundary between the first domain and the second domain. At this time, by setting the relationship between the ends of the first slits 112A to 112G, 142A to 142H, 212A to 212H, 242A to 242H that are closer to the boundary region 131, 161, 231, 261 and the ends of the second slits 122A to 122H, 152A to 152H, 222A to 222H, 252A to 252I that are closer to the boundary region 131, 161, 231, 261 as described above, a disclination P101, P111, P201 to P203, P211 to P213 of the double dark line can be caused in a specific site on the boundary region. Therefore, variation in the sites of occurrence of the disclinations P101, P111, P201 to P203, P211 to P213 can be suppressed, thereby making it possible to improve on coarseness of display and provide an enhanced display quality.

In a liquid crystal display panel according to one embodiment,

among the ends of the plurality of first slits 112A to 112G, 142A to 142H, 212A to 212H, 242A to 242H that are closer to the boundary region 131, 161, 231, 261, a plurality of ends are adjacent to the first portion 131a, 161a, 231a, 261a of the boundary region 131, 161, 231, 261, and a plurality of ends are adjacent to the second portion 131b, 161b, 231b, 261b of the boundary region 131, 161, 231, 261; and

among the ends of the plurality of second slits 122A to 122H, 152A to 152H, 222A to 222H, 252A to 252I that are closer to the boundary region 131, 161, 231, 261, a plurality of ends are adjacent to the first portion 131a, 161a, 231a, 261a of the boundary region 131, 161, 231, 261, and a plurality of ends are adjacent to the second portion 131b, 161b, 231b, 261b of the boundary region 131, 161, 231, 261.

According to the above embodiment, since there are pluralities of such ends, the effect of suppressing variation in the sites of occurrence of a disclination P101, P111, P201 to P203, P211 to P213 can be enhanced.

In a liquid crystal display panel according to one embodiment, an end that is adjacent to the first portion 131a, 161a, 231a, 261a of the boundary region 131, 161, 231, 261 among the ends of the plurality of first slits 112A to 112G, 142A to 142H, 212A to 212H, 242A to 242H that are closer to the boundary region 131, 161, 231, 261 and an end that is adjacent to the first portion 131a, 161a, 231a, 261a of the boundary region 131, 161, 231, 261 among the ends of the plurality of second slits 122A to 122H, 152A to 152H, 222A to 222H, 252A to 252I that are closer to the boundary region 131, 161, 231, 261 are opposed to each other in a direction along the longitudinal direction of the pixel 101; and

an end that is adjacent to the second portion 131b, 161b, 231b, 261b of the boundary region 131, 161, 231, 261 among the ends of the plurality of first slits 112A to 112G, 142A to 142H, 212A to 212H, 242A to 242H that are closer to the boundary region 131, 161, 231, 261 and an end that is adjacent to the second portion 131b, 161b, 231b, 261b of the boundary region 131, 161, 231, 261 among the ends of the plurality of second slits 122A to 122H, 152A to 152H, 222A to 222H, 252A to 252I that are closer to the boundary region 131, 161, 231, 261 are opposed to each other in the direction along the longitudinal direction of the pixel 101.

According to the above embodiment, by setting the relationship in the positions of the ends of the first slits 112A to 112G, 142A to 142H, 212A to 212H, 242A to 242H that are closer to the boundary region 131, 161, 231, 261 and the ends of the second slits 122A to 122H, 152A to 152H, 222A to 222H, 252A to 252I that are closer to the boundary region 131, 161, 231, 261 as described above, the effect of suppressing variation in the sites of occurrence of a disclination P101, P111, P201 to P203, P211 to P213 can be enhanced.

In a liquid crystal display panel according to one embodiment,

a figure that is presented by the ends of the plurality of first slits 112D to 112G, 142A to 142D, 212D to 212G, 242A to 242D that are closer to the boundary region 131, 161, 231, 261 and the ends of the plurality of second slits 122A to 122D, 152E to 152H, 222A to 222D, 252E to 252H that are closer to the boundary region 131, 161, 231, 261 is a point-symmetric figure.

According to the above embodiment, a figure that is presented by the ends of the plurality of first slits 112D to 112G, 142A to 142D, 212D to 212G, 242A to 242D that are closer to the boundary region 131, 161, 231, 261 and the ends of the plurality of second slits 122A to 122D, 152E to 152H, 222A to 222D, 252E to 252H that are closer to the boundary region 131, 161, 231, 261 is a point-symmetric figure, whereby the effect of suppressing variation in the sites of occurrence of a disclination P101, P111, P201 to P203, P211 to P213 can be enhanced.

In a liquid crystal display panel according to one embodiment,

the boundary region 131, 161, 231, 261 has a width along the longitudinal direction of the pixel 101; and

the width is narrower than a width of at least one of: the first slits 112A to 112G, 142A to 142H, 212A to 212H, 242A to 242H; and the second slits 122A to 122H, 152A to 152H, 222A to 222H, 252A to 252I.

According to the above embodiment, because of being narrower than the width of at least one of: the first slits 112A to 112G, 142A to 142H, 212A to 212H, 242A to 242H; and the second slits 122A to 122H, 152A to 152H, 222A to 222H, 252A to 252I, the region in which a double dark line will occur under an applied voltage can be narrowed in a region corresponding to the pixel electrode 102, 202 of the liquid crystal display panel. As a result, decrease in transmittance can be suppressed effectively.

### REFERENCE SIGNS LIST

10 first substrate section,
11 first glass substrate
20 first vertical alignment film
78
30 liquid crystal layer
41 liquid crystal molecule
40 second vertical alignment film
50 second substrate section
51 second glass substrate
90 sealing member
101 pixel
101a to 101d domain
102, 202 pixel electrode
103 counter electrode
102a, 202a first pixel electrode portion
102b, 202b second pixel electrode portion
111, 141, 211, 241 first slitted region
112A to 112G, 122A to 112H, 142A to 142H, 152A to 152H, 212A to 212H, 222A to 222H, 242A to 242H, 252A to 252I slit
121, 151, 221, 251 second slitted region
131, 161, 231, 261 boundary region
131a, 161a, 231a, 261a first portion
131b, 161b, 231b, 261b second portion
C101, C201 center line

1. A liquid crystal display panel having a display mode that is a VA mode, comprising:
a plurality of rectangular-shaped pixels;
a first substrate section including a first substrate and pixel electrodes;
a liquid crystal layer provided on the first substrate section, the liquid crystal layer containing liquid crystal molecules; and
a second substrate section provided on the liquid crystal layer, the second substrate section including a second substrate and a counter electrode, wherein,
the plurality of pixels each include first and second domains arranged along a longitudinal direction of the pixel; when a direction orthogonal to the longitudinal direction of the pixel is defined as a transverse direction of the pixel and an azimuth flush with the transverse direction of the pixel is defined as 0°, an alignment azimuth of the liquid crystal molecules in the first domain is substantially 45° and an alignment azimuth of the liquid crystal molecules in the second domain is substantially 225°; or an alignment azimuth of the liquid crystal molecules in the first domain is substantially 135° and an alignment azimuth of the liquid crystal molecules in the second domain is substantially 315°;
each pixel electrode includes
a first slitted region in which a plurality of first slits extending along a direction that is parallel to the alignment azimuth of the liquid crystal molecules in the first domain are formed, and
a second slitted region in which a plurality of second slits extending along a direction that is parallel to the alignment azimuth of the liquid crystal molecules in the second domain are formed, and
a boundary region provided between the first slitted region and the second slitted region;
no slits are formed in the boundary region;
when a center line which extends along the longitudinal direction of the pixel and which passes through a center of a width direction of the pixel electrode is defined, the boundary region includes a first portion provided on one side of the center line along the transverse direction and a second portion provided on another side of the center line along the transverse direction;
among ends of the plurality of first slits that are closer to the boundary region, an end that is adjacent to the first portion of the boundary region is located nearer the boundary region than is an end that is adjacent to the second portion of the boundary region; and
among ends of the plurality of second slits that are closer to the boundary region, an end that is adjacent to the second portion of the boundary region is located nearer the boundary region than is an end that is adjacent to the first portion of the boundary region.

2. The liquid crystal display panel of claim 1, wherein,
among the ends of the plurality of first slits that are closer to the boundary region, a plurality of ends are adjacent to the first portion of the boundary region, and a plurality of ends are adjacent to the second portion of the boundary region; and
among the ends of the plurality of second slits that are closer to the boundary region, a plurality of ends are adjacent to the first portion of the boundary region, and a plurality of ends are adjacent to the second portion of the boundary region.

3. The liquid crystal display panel of claim 1,
an end that is adjacent to the first portion of the boundary region among the ends of the plurality of first slits that are closer to the boundary region and an end that is adjacent to the first portion of the boundary region among the ends of the plurality of second slits that are closer to the boundary region are opposed to each other in a direction along the longitudinal direction of the pixel; and
an end that is adjacent to the second portion of the boundary region among the ends of the plurality of first slits that are closer to the boundary region and an end that is adjacent to the second portion of the boundary region among the ends of the plurality of second slits that are closer to the boundary region are opposed to each other in the direction along the longitudinal direction of the pixel.

4. The liquid crystal display panel of claim 1, wherein
a figure that is presented by the ends of the plurality of first slits that are closer to the boundary region and the ends of the plurality of second slits that are closer to the boundary region is a point-symmetric figure.

5. The liquid crystal display panel of claim 1, wherein,
the boundary region has a width along the longitudinal direction of the pixel; and
the width is narrower than a width of at least one of: the first slits; and the second slits.
